(19) United States
(12) Patent Application Publication
(10) Pub. No.: US 2021/0219412 A1
(43) Pub. Date: Jul. 15, 2021

(54) NOZZLES FOR LIQUID COOLED PLASMA ARC CUTTING TORCHES WITH CLOCKING-INDEPENDENT PASSAGES

(71) Applicant: Hypertherm, Inc., Hanover, NH (US)

(72) Inventors: Adam Chevalier, Orford, NH (US); John Peters, Canaan, NH (US); Brandon Mason, Grantham, NH (US)

(21) Appl. No.: 17/144,845

(22) Filed: Jan. 8, 2021

Related U.S. Application Data
(60) Provisional application No. 62/959,035, filed on Jan. 9, 2020.

(51) Int. Cl. H05H 1/28; B23K 10/00; H05H 1/34

(52) U.S. Cl. CPC H05H 1/28; B23K 10/00; H05H 2001/3457; H05H 2001/3478; H05H 1/34

(57) ABSTRACT

A nozzle for a liquid cooled plasma arc cutting torch is provided. The nozzle includes a hollow nozzle body and a nozzle jacket disposed about an external surface of the nozzle body. The jacket defines (i) a length along the central longitudinal axis and (ii) a diameter of a distal tip of the jacket at the distal region of the nozzle, where the length is greater than about 1.5 inches and a ratio of the length to the diameter is greater than about 1.4. The nozzle also includes a coolant inlet and a coolant outlet defined between the nozzle body and nozzle jacket at the proximal region of the nozzle. The nozzle further includes a plurality of coolant channels cooperatively defined between the nozzle body and the nozzle jacket. The plurality of coolant channels extend axially between the proximal region and the distal region of the nozzle.

### CROSS REFERENCE TO RELATED APPLICATION

This application claims the benefit of and priority to U.S. Provisional Patent Application No. 62/959,035, filed Jan. 9, 2020, the entire content of which is owned by the assignee of the instant application and is incorporated herein by reference in its entirety.

### TECHNICAL FIELD

The present invention generally relates to nozzles for liquid-cooled plasma arc cutting torches, and more particularly, to nozzles with clocking-independent cooling features and passages.

### BACKGROUND

Thermal processing torches, such as plasma arc torches, are widely used for high temperature processing (e.g., heating, cutting, gouging, and marking) of materials. A plasma arc torch generally includes a torch body, an electrode mounted within the torch body, an emissive insert disposed within a bore of the electrode, a nozzle with a central exit orifice mounted within the torch body, a shield, electrical connections, passages for cooling, passages for arc control fluids (e.g., plasma gas), and a power supply. A swirl ring can be used to control fluid flow patterns in the plasma chamber formed between the electrode and the nozzle. In some torches, a retaining cap is used to maintain the nozzle and/or swirl ring in the plasma arc torch. In operation, the torch produces a plasma arc, which is a constricted jet of an ionized gas with high temperature and sufficient momentum to assist with removal of molten metal. Gases used in the torch can be non-reactive (e.g., argon or nitrogen), or reactive (e.g., oxygen or air).

Design considerations for a plasma arc torch include features for cooling, since the arc generated can produce temperatures in excess of 10,000° C., which, if not controlled, can destroy the torch, particularly the nozzle itself. Thus, the erosion rate of the nozzle is affected by the cooling efficiency at the nozzle. Efficient cooling can help to maintain a relatively low temperature, which leads to a lower erosion rate. Additionally, because a nozzle deteriorates over time from use, it needs to be easily replaceable in the field. Hence, clocking-independent installation of the nozzle is preferable.

When a consumable component is on a coolant flow path inside of a plasma arc torch, it can be relatively straightforward to force the flow path through and/or around the consumable component to cool the component while not requiring the consumable component to clock (i.e., maintain a specific orientation) relative to the other torch components or for its own sub-components, but this favorable condition is only likely to occur when the inlet and outlet of the coolant flow are axially offset. For example, this clocking independent feature can be accomplished by forming on the consumable component two axially spaced, circumferential grooves (as an inlet and an outlet) with a relatively fluid-tight seal between them. FIG. 1 shows an exemplary prior art nozzle 100 for a liquid-cooled plasma arc cutting torch with a pair of axially spaced coolant inlet 102 and coolant outlet 104 as described above. As shown, each of the coolant inlet 102 and the coolant outlet 104 is a circumferential groove formed by a close fit between an outer nozzle jacket 112 and a nozzle retaining cap 110. With the inlet 102 and the outlet 104 offset by an axial distance 106 and sealed from one another, the coolant flow path 108 is forced to extend both axially through and circumferentially around the nozzle 100 at its distal tip 116 to provide effective cooling (e.g., the coolant flow path 108 cannot short circuit the desired coolant path and simply flow circumferentially around the proximal end of the nozzle 100 straight from the inlet 102 to the outlet 104). Specifically, the coolant can travel in a path 108 along one or more supply channels extending over the length of the nozzle 100 to cool the nozzle tip 116 and return over one or more return channels extending substantially over the length of the nozzle 100, where these channels are located between an inner nozzle body 114 and the outer nozzle jacket 112 of the nozzle 100.

An alternative nozzle design involves having inlet and outlet areas defined as openings on the nozzle exterior (e.g., through the nozzle jacket) with flow channels inside of the nozzle (e.g., between the nozzle jacket and the nozzle body), thereby forcing the coolant to follow a preferred flow path to and from the nozzle tip. This configuration, however, requires clocking of the nozzle components during manufacturing and/or fixing the nozzle in a specific orientation/alignment with the torch body during assembly so that coolant from the torch body can be directed along the channel(s) extending over the length of the nozzle to cool the nozzle and return the coolant flow to the torch body.

In general, these clocking-dependent prior art designs require multistep machining, inspection, inventory, part numbers etc. that increases not only the complexity and cost of manufacturing the consumable components, but also the supply chain complexity and cost.

### SUMMARY

It is therefore an objective of the present invention to provide nozzle designs that optimize coolant flow through the nozzles, thereby improving service life of the nozzles and increasing cut quality. It is another objective of the present invention to provide clocking-independent nozzles to facilitate assembly within plasma arc torches.

In one aspect, a nozzle for a liquid cooled plasma arc cutting torch is provided. The nozzle defines a central longitudinal axis extending between a proximal region and a distal region of the nozzle with a plasma exit orifice disposed along the longitudinal axis at the distal region. The nozzle includes a hollow nozzle body, and a nozzle jacket disposed about an external surface of the nozzle body. The jacket defines (i) a length along the central longitudinal axis and (ii) a diameter of a distal tip of the jacket at the distal region of the nozzle, where the length is greater than about 1.5 inches and a ratio of the length to the diameter is greater than about 1.4. The nozzle also includes a coolant inlet and a coolant outlet defined between the nozzle body and nozzle jacket at the proximal region of the nozzle. The coolant inlet is configured to receive a liquid coolant flow from a torch body of the plasma arc cutting torch to cool the nozzle and the coolant outlet is configured to return the coolant flow to the torch body. The nozzle also includes a plurality of coolant channels cooperatively defined between the nozzle body and the nozzle jacket. The plurality of coolant channels extend axially between the proximal region and the distal region of the nozzle.

In another aspect, a nozzle for a liquid cooled plasma arc cutting torch is provided. The nozzle defines a central longitudinal axis extending between a proximal region and a distal region of the nozzle. The nozzle comprises a nozzle body including an internal surface shaped to form a portion of a plasma plenum and an external surface shaped to form a portion of a coolant flow path substantially about the nozzle body. The external surface defines a plurality of substantially axial channels extending from the proximal region to the distal region of the nozzle. The nozzle also includes a nozzle jacket disposed about the external surface of the nozzle body and shaped to cooperatively form the plurality of axial channels with the nozzle body. The plurality of axial channels define the coolant flow path about the nozzle body. The nozzle further includes a plurality of windows disposed into the nozzle body. Each window is circumferentially defined by a pair of adjacent dividers of the nozzle body to prevent the coolant flow path through one window from flowing circumferentially into an adjacent window.

In yet another aspect, a consumable set in a liquid cooled plasma arc cutting torch is provided, where the consumable set is configured to direct a plasma arc to process a workpiece. The consumable set comprises an electrode and a nozzle disposed about the electrode. The nozzle has a nozzle body, a nozzle jacket and a plurality of windows. An external surface of the nozzle body and an internal surface of the nozzle jacket cooperatively define a plurality of axial channels for circulating a coolant flow about the nozzle. Each axial channel is located within one of the windows that is defined by a pair of adjacent dividers configured to prevent the coolant flow in one window from circumferentially bypassing into an adjacent window. The consumable set further comprises a shield disposed about the nozzle jacket.

In yet another aspect, a nozzle for a liquid cooled plasma arc cutting torch is provided. The nozzle defines a central longitudinal axis extending between a proximal region and a distal region of the nozzle with a plasma exit orifice disposed along the longitudinal axis at the distal region. The nozzle includes a hollow nozzle body, a nozzle jacket disposed about an external surface of the nozzle body, and a coolant inlet and a coolant outlet defined between the nozzle body and nozzle jacket at the proximal region of the nozzle. The coolant inlet is configured to receive a liquid coolant flow from a torch body of the plasma arc cutting torch to cool the nozzle and the coolant outlet is configured to return the liquid coolant flow to the torch body. The nozzle also includes a plurality of windows cooperatively defined between the nozzle body and the nozzle jacket and located at the proximal region of the nozzle. The plurality of windows includes at least a first window in fluid communication with the coolant inlet for receiving the liquid coolant flow from the coolant inlet and flowing the liquid coolant to the nozzle, and at least a second window in fluid communication with the coolant outlet for returning the liquid coolant flow from the nozzle to the coolant outlet. The first and second windows are in fluid communication with each other within the nozzle. The nozzle further includes a plurality of axial channels cooperatively defined between the nozzle body and the nozzle jacket. Each of the plurality of axial channels extends between the proximal and distal regions of the nozzle. The plurality of axial channels include a single axial channel in fluid communication with one of the first or second window, and a pair of axial channels in fluid communication with another of the first or second window. The pair of axial channels are located substantially circumferentially opposite from the single axial channel. The single axial channel and the pair of axial channels are in fluid communication at the distal region of the nozzle for passing the liquid coolant flow between the first and second windows, such that a desired pressure drop for the liquid coolant flow is established between the single axial channel and the pair of axial channels independent of a circumferential orientation of the nozzle body relative to the nozzle jacket.

In other examples, any of the aspects above can include one or more of the following features. In some embodiments, the coolant inlet and the coolant outlet are (i) substantially axially aligned along the longitudinal axis and (ii) circumferentially offset relative to each other.

In some embodiments, a plurality of windows are disposed into the nozzle body, each window being circumferentially defined by a pair of adjacent dividers of the nozzle body. In some embodiments, each divider is configured to prevent the coolant flow in one window from flowing circumferentially into an adjacent window to restrict coolant flow bypass. In some embodiments, each coolant channel is disposed in the nozzle body within a corresponding window such that the coolant channel is located between a pair of the dividers associated with the corresponding window. In some embodiments, each axial coolant channel is circumferentially isolated from one another via the dividers of the windows.

In some embodiments, the coolant inlet is in fluid communication with at least one of the plurality of windows, such that the coolant flow received from the coolant inlet is adapted to flow through the at least one coolant channel associated with the corresponding window. In some embodiments, one of the plurality of coolant channels is in fluid communication with one of the coolant inlet or outlet, and two of the plurality of coolant channels are in fluid communication with other one of the coolant inlet or outlet, irrespective of a radial orientation between the nozzle jacket and the nozzle body. In some embodiments, at least one of the plurality of coolant channels is fluidly insulated from the coolant inlet and the coolant outlet, thereby prevented from conducting a fluid flow therethrough. In some embodiments, two windows of the plurality of windows are in fluid communication with a coolant inlet or a coolant outlet of the nozzle, and the two windows are fluidly connected to respective ones of the axial coolant channels, such that the corresponding coolant inlet or outlet is fluidly connected to two axial coolant channels irrespective of a circumferential orientation between the nozzle jacket and the nozzle body. In some embodiments, one window of the plurality of windows is in fluid communication with a coolant inlet or a coolant outlet of the nozzle, and the one window is fluidly connected to a corresponding axial channel, such that the corresponding coolant inlet or outlet is fluidly connected to one axial channel irrespective of a circumferential orientation between the nozzle jacket and the nozzle body.

In some embodiments, the jacket includes a distal conical section that axially extends about 50% of the length of the jacket. The distal conical section has (i) a proximal end axially located at about a midpoint of the jacket length and (ii) a distal end tapered radially inward at the distal tip of the jacket. In some embodiments, the distal conical section comprises two angled sections, a first angled section radially extending from the midpoint of the jacket length toward the distal end of the nozzle, and a second angled section extending from the first angled section to the distal tip of the jacket. The first angled section defines a first angle relative to the longitudinal axis and the second angled section defines a second angle relative to the longitudinal axis. The second angle is larger than the first angle such that the second angled section is more tapered than the first angled section. In some embodiments, the first angle is about 14 degrees and the second angle is about 23.5 degrees. In some embodiments, a shield is disposed about an external surface of the nozzle jacket. The shield comprises a distal conical section with two angled sections, each angled section having about the same angle as the corresponding section of the nozzle jacket. In some embodiments, a diameter of an end face at a distal tip of the shield is about 0.45 inches. The shield can comprise substantially same shape and one or more angled sections as the nozzle jacket.

In some embodiments, the plurality of liquid coolant channels axially extend at least about 75% of the length of the nozzle jacket. In some embodiments, each coolant channel has a substantially rectangular cross section. In some embodiments, an axial length of each coolant channel is greater than about 1.2 inches. In some embodiments, a width of each coolant channel is less than about 0.2 inches. In some embodiments, the diameter of the distal tip of the jacket is less than about 0.4 inches.

In some embodiments, the nozzle jacket defines (i) a length along the central longitudinal axis and (ii) a diameter of a distal tip of the jacket at the distal region of the nozzle. The length is greater than about 1.5 inches and a ratio of the length to the diameter is greater than about 1.4.

In some embodiments, the plurality of coolant channels fluidly merge into a circumferential channel at the distal region of the nozzle. The circumferential channel is configured to circumferentially circulate a coolant flow about the distal region of the nozzle. In some embodiments, the circumferential channel is defined at least in part by a sealing member disposed between the nozzle body and the nozzle jacket. The sealing member has a diameter of between about 0.15 inches and about 0.3 inches.

In some embodiments, the plasma arc torch is configured to operate at a current level of above about 120 amps. In some embodiments, both the nozzle body and the nozzle jacket are electrically conductive. In some embodiments, the nozzle jacket is constructed from brass.

In some embodiments, the plurality of windows comprise a plurality of holes formed through the nozzle jacket.

In some embodiments, an axial length of the electrode is greater than about 2.4 inches. In some embodiments, the electrodes includes a cooling bore having an axial length greater than about 1.8 inches. In yet another aspect, a method of conducting a liquid coolant through a nozzle of plasma arc cutting torch is provided. The nozzle defines a central longitudinal axis extending between a proximal region and a distal region of the nozzle. The method includes supplying the liquid coolant to a coolant inlet in the proximal region of the nozzle between a hollow nozzle body and a nozzle jacket disposed about the hollow nozzle body. An external surface of the nozzle body and an internal surface of the nozzle jacket cooperatively define a plurality of axial channels that extend from the proximal region to the distal region. The method also includes flowing the liquid coolant from the coolant inlet to at least a first window of a plurality of windows disposed into the nozzle body. Each window is circumferentially defined by a pair of adjacent dividers of the nozzle body, and each window includes at least one of the plurality of axial channels. The method includes conducting the liquid coolant to the distal region of the nozzle via at least a first axial channel associated with the first window while preventing the liquid coolant from flowing circumferentially into an adjacent window by the pair of dividers of the first window. The method includes returning the liquid coolant from the distal region to the proximal region of the nozzle via at least a second axial channel of the plurality of axial channels. The at least second axial channel is located in a second window of the plurality of windows and the second window being in fluid communication with a coolant outlet located between the nozzle body and the nozzle jacket in the proximal region. The method further includes expelling the liquid coolant from of the nozzle via the coolant outlet at the proximal region of the nozzle.

In some embodiments, the coolant inlet is fluid communication with at least the first axial channel and the coolant outlet is in fluid communication with at least the second axial channel irrespective of a circumferential orientation between the nozzle body and the nozzle jacket.

In some embodiments, the method further comprises achieving a desired pressure disparity between the liquid coolant flow to the distal region and the liquid coolant flow to the proximal region irrespective of a radial orientation of the nozzle body relative to the nozzle jacket.

In some embodiments, the method further comprises conducting the liquid coolant to the distal region of the nozzle via a pair of the plurality of axial channels corresponding to respective ones of a pair of the plurality of windows, where the pair of windows being in fluid communication with the coolant inlet, and returning the liquid coolant to the proximal region of the nozzle via a single one of the plurality of axial channels corresponding to a single one of the plurality of windows. The single window is in fluid communication with the coolant outlet. The single axial channel is (i) located substantially circumferentially opposite from the pair of axial channels and (ii) in fluid communication with the pair of axial channels at the distal region of the nozzle.

In some embodiments, the method further comprises conducting the liquid coolant to the distal region of the nozzle via a single one of the plurality of axial channels corresponding to a single one of the plurality of windows, where the single window is in fluid communication with the coolant inlet, and returning the liquid coolant to the proximal region of the nozzle via a pair of the plurality of axial channels corresponding to respective ones of a pair of the plurality of windows. The pair of windows are in fluid communication with the coolant outlet. The single axial channel is (i) located substantially circumferentially opposite from the pair of axial channels and (ii) in fluid communication with the pair of axial channels at the distal region of the nozzle.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary prior art nozzle for a liquid-cooled plasma arc cutting torch with a pair of axially spaced coolant inlet and coolant outlet ports.

FIG. 2 shows a cross-sectional view of an exemplary liquid-cooled plasma arc torch incorporating a clocking-independent nozzle, according to some embodiments of the present invention.

FIGS. 3a and 3b show sectioned and profile views, respectively, of the proximal region of the clocking-independent nozzle of FIG. 2, according to some embodiments of the present invention.

FIG. 4 shows a profile view of the nozzle body of the clocking-independent nozzle of FIG. 2, according to some embodiments of the present invention.

FIG. 5 shows a profile view of the nozzle jacket of the clocking-independent nozzle of FIG. 2, according to some embodiments of the present invention.

FIG. 6 shows a stack-up comparison of a prior art liquid-cooled plasma arc torch with the liquid-cooled plasma arc torch of FIG. 2, according to some embodiments of the present invention.

FIGS. 7a and 7b show utilization of the plasma arc torch of FIG. 2 in cutting a workpiece at an angle close to parallel to the surface of the workpiece, according to some embodiments of the present invention.

FIG. 8 shows an exemplary process for conducting a liquid coolant through the clocking-independent nozzle of the plasma arc torch of FIG. 2, according to some embodiments of the present invention.

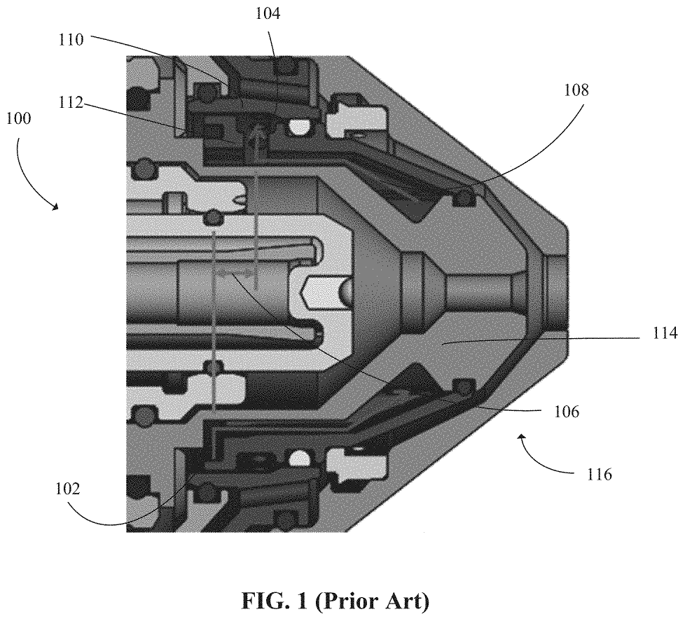

### DETAILED DESCRIPTION

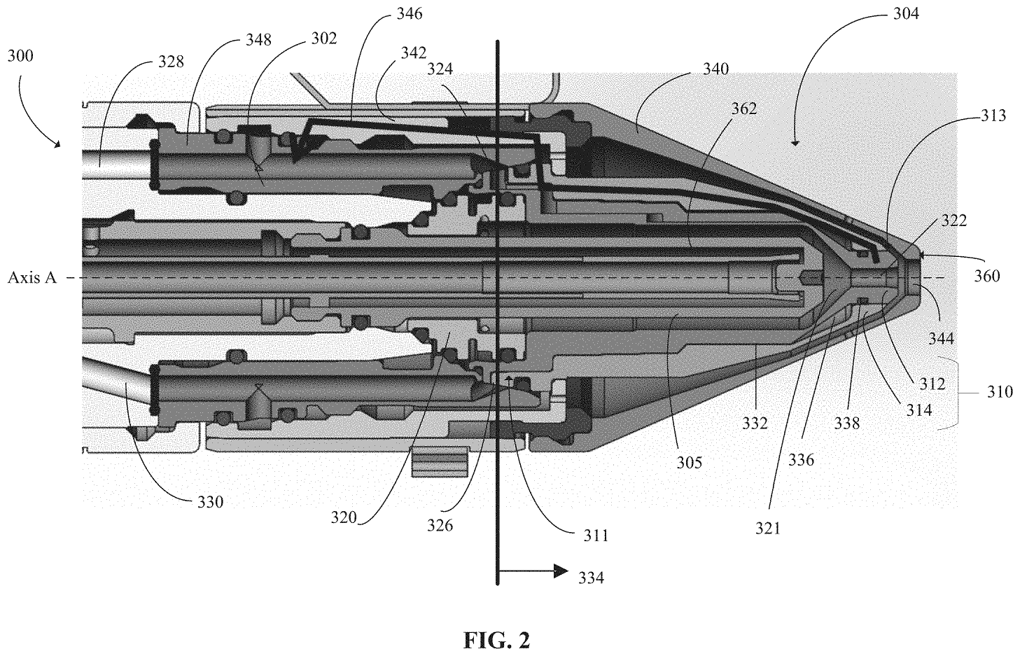

FIG. 2 shows a cross-sectional view of an exemplary liquid-cooled plasma arc torch 300 incorporating a clocking-independent nozzle 310, according to some embodiments of the present invention. The torch 300 defines a central longitudinal axis A along which a torch body 302 is connected to a torch tip 304 comprising multiple consumable components, such as an electrode 305, the clocking-independent nozzle 310, a swirl ring 320, and an optional shield 340. In some embodiments, the plasma arc torch 300 is configured to operate at a current level above about 120 amps. Hereinafter a proximal region of a component of the torch 300 is defined as a region of the component along the longitudinal axis A that is away from a workpiece (not shown) when the torch 300 is used to process the workpiece, and a distal region of the torch component is defined as a region of the component opposite of the proximal region and closest to the workpiece when the torch 300 is used to process the workpiece.

Within the torch tip 304, the clocking-independent nozzle 310 is spaced distally from the electrode 305 to cooperatively define a plasma plenum 321. As shown, the nozzle 310 includes (i) an elongated inner nozzle body 312 that is substantially hollow and (ii) an elongated outer nozzle jacket 314 disposed about and substantially surrounding an external surface of the inner nozzle body 312. The swirl ring 320 is mounted between the torch body 302 and the nozzle 310 and has a set of radially offset or canted gas distribution holes that impart a tangential velocity component to the plasma gas flow therethrough. A retaining cap 342 can be used to securely retain the nozzle 310 to the torch body 302 while radially and/or axially positioning the nozzle 310 with respect to the longitudinal axis A. The shield 340 can be disposed about an external surface of the nozzle jacket 314 and secured (e.g., threaded) to the torch body 302 via the retaining cap 342. The shield 340 includes a shield exit orifice 344 for introducing a plasma arc to a workpiece during processing.

In general, the nozzle 310 defines a proximal region 311 and a distal region 313 disposed along the central longitudinal axis A. At the distal region 313 of the nozzle 310, an internal surface of the nozzle body 312 is shaped to form at least a portion of the plasma plenum 321 as well as a nozzle exit orifice 322, which in combination with the shield exit orifice 344, define a plasma arc exit orifice through which a plasma arc is delivered to a workpiece during torch operation. At the proximal region 311 of the nozzle 310, a coolant inlet 324 and a coolant outlet 326 are defined between the nozzle body 312 and the nozzle jacket 314. The coolant inlet 324 is configured to receive a liquid coolant flow from the torch body 302 (e.g., via the coolant inlet channel 328 of the torch body 302) to cool the nozzle 310, and the coolant outlet 326 is configured to return the coolant flow from the nozzle 310 to the torch body 302 (e.g., by supplying the coolant flow to the coolant return channel 330 of the torch body 302).

In some embodiments, the nozzle 310 includes multiple coolant channels 332 cooperatively defined between an external surface of the nozzle body 312 and an internal surface of the nozzle jacket 314. For example, the multiple coolant channels 332 can be disposed in the nozzle body 312 and dispersed circumferentially about the nozzle body 312, where each coolant channel 332 is configured to extend axially between the proximal region 311 and the distal region 313 of the nozzle 310. At the distal region 313 of the nozzle 310, these coolant channels 332 fluidly communicate with one another, such as, in some embodiments, merge into a circumferential channel 336 located between the nozzle body 312 and the nozzle jacket 314 at the distal region 313. The circumferential channel 336 can comprise a cavity disposed into the nozzle body 312 from an external surface of the nozzle body 312. The circumferential channel 336 is configured to circumferentially circulate a coolant flow received from one or more of the axially-extending coolant channels 332 about the distal region 313 of the nozzle 310. As shown in FIG. 2, the circumferential channel 336 can be defined at least in part by a sealing member 338 (e.g., an O-ring) disposed between the nozzle body 312 and the nozzle jacket 314 in the distal region 313 of the nozzle 310. The placement of the sealing member 338 is such that it is recessed/located away from the nozzle exit orifice 322. This sealing member 338 is configured to prevent liquid coolant in the circumferential channel 336 from leaking out of the nozzle 310 and reaching the nozzle exit orifice 322. In some embodiments, the sealing member 338 has a diameter of between about 0.15 inches and about 0.3 inches, such as between about 0.2 inches and about 0.22 inches.

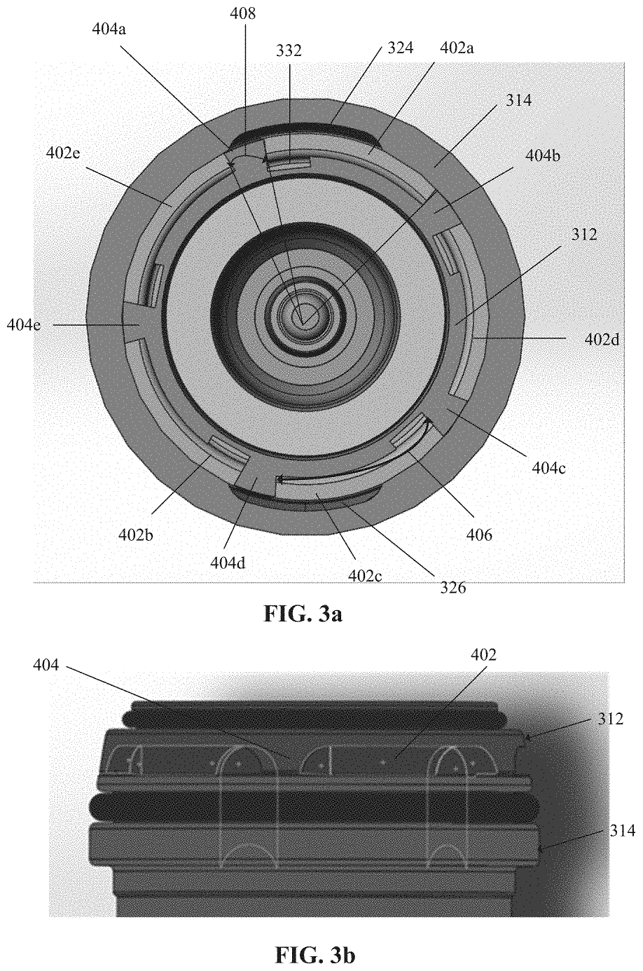

FIGS. 3a and 3b show sectioned and profile views, respectively, of the proximal region 311 of the nozzle 310 of FIG. 2, according to some embodiments of the present invention. Specifically, in FIG. 3a, the sectioned view of the proximal region 311 of the nozzle 310 is taken at the plane 334 indicated on FIG. 2, where the plane 334 is oriented substantially orthogonal to the longitudinal axis A and extends through the coolant inlet 324 and the coolant outlet 326 of the nozzle 310. As shown, the coolant inlet 324 and the coolant outlet 326 can be substantially axially aligned along the longitudinal axis A, but circumferentially offset relative to each other, such as about 180 degrees offset from each other. In some embodiments, multiple windows 402a-e (collectively referred to as 402) are disposed into the nozzle body 312 from an external surface of the nozzle body 312, where each window 402 is circumferentially defined by a pair of adjacent dividers 404 of the nozzle body 312 that comprise radially-extending projections. FIGS. 3a and 3b illustrate five dividers 404a-e, which are generally referred to as 404. Each window 402 can comprise a relatively wide opening on the external surface of the nozzle body 312, and each divider 404 can comprise a radially-extending projection defined by the nozzle body 312. Further, each of the multiple coolant channels 332 is disposed in the nozzle body 312 within a window 402, such that each coolant channel 332 is located between a pair of the dividers 404 defining the corresponding window 402. Each coolant channel 332 can extend axially along the length of the nozzle body 312 from the proximal region 311 to the distal region 313 of the nozzle 310. In some embodiments, a divider 404 between two windows 402 can maintain physical contact with an interior surface of the nozzle jacket 314, thus substantially preventing a liquid coolant flow in the coolant channel 332 of one window 402 from traveling circumferentially into the coolant channel 332 of an adjacent window 402. Thus, when a divider 404 is in physical contact with the nozzle jacket 314, it restricts circumferential coolant flow bypass between coolant channels 332 located in adjacent windows 402 and separated by the divider 404. In some embodiments, the windows 402, dividers 404 and coolant channels 332 are evenly distributed around a circumference of the nozzle body 312. In some embodiments, each window includes at least one coolant channel 332 (e.g., just one coolant channel 332).

In some embodiments, at least one of the windows 402 (including the coolant channel(s) 332 located within that window 402), such as window 402a in FIG. 3a, is in fluid communication with the coolant inlet 324, and at least another one of the remaining windows 402 (including the coolant channel(s) 332 located in the other window 402), such as windows 402b, 402c in FIG. 3a, is in fluid communication with the coolant outlet 326, irrespective of a radial orientation between the nozzle body 312 and the nozzle jacket 314. The remaining windows 402 and their corresponding channels 332 are circumferentially fluidly insulated from the coolant inlet 324 and the coolant outlet 326, and thereby prevented from conducting a coolant into or away from the nozzle 310.

For example, one window 402 (including the coolant channel(s) 332 located within that window 402) can be in fluid communication with one of the coolant inlet 324 or outlet 326, and two of the remaining windows 402 (including the coolant channels 332 located in these two windows 402) can be in fluid communication with the other one of the coolant inlet 324 or outlet 326, independent of a radial orientation between the nozzle body 312 and the nozzle jacket 314. As shown in FIG. 3a, the coolant inlet 324 is in fluid communication with one window 402a, whereas the coolant outlet 326 is in fluid communication with two adjacent windows 402b, 402c. Specifically, for window 402a, the pair of dividers 404a, 404b defining the window 402a are both in physical contact with the corresponding interior surfaces of the nozzle jacket 314 on either side of the inlet 324, thereby restricting the coolant received from the inlet 324 to flow through only the coolant channel(s) 332 within the window 402a. For adjacent windows 402b and 402c, the divider 404d between these two windows does not contact an interior surface of the nozzle jacket 314, but is aligned with the outlet 326, thereby allowing the coolant from the coolant channels 332 corresponding to both windows 402b, 402c to be in fluid communication with the outlet 326. In alternative embodiments, two of the windows 402 are in fluid communication with the coolant inlet 324 and one of the windows 402 is in fluid communication with the coolant outlet 326. Further, the remaining two windows 402d, 402e are circumferentially fluidly insulated from the coolant inlet 324 and outlet 326 in the proximal region 311 because these windows are not aligned with either the coolant inlet 324 or outlet 326 and the dividers 404 defining these windows are in physical contact with the nozzle jacket 312 to prevent any circumferential coolant flow bypass.

In some embodiments, each window 402 maintains an angular span 406 of about 45 degrees. In some embodiments, an angular span 408 of each divider 404 is less than the angular span 406 of each window 401, but is sufficiently wide to avoid undercutting from an endmill operation (e.g., during the component manufacturing process) to form the windows 402, while being able to restrict flow bypass around a circumference of the nozzle 310. For example, each divider 404 can have an angular span 408 of between about 5 degrees and about 30 degrees, such as about 13 degrees.

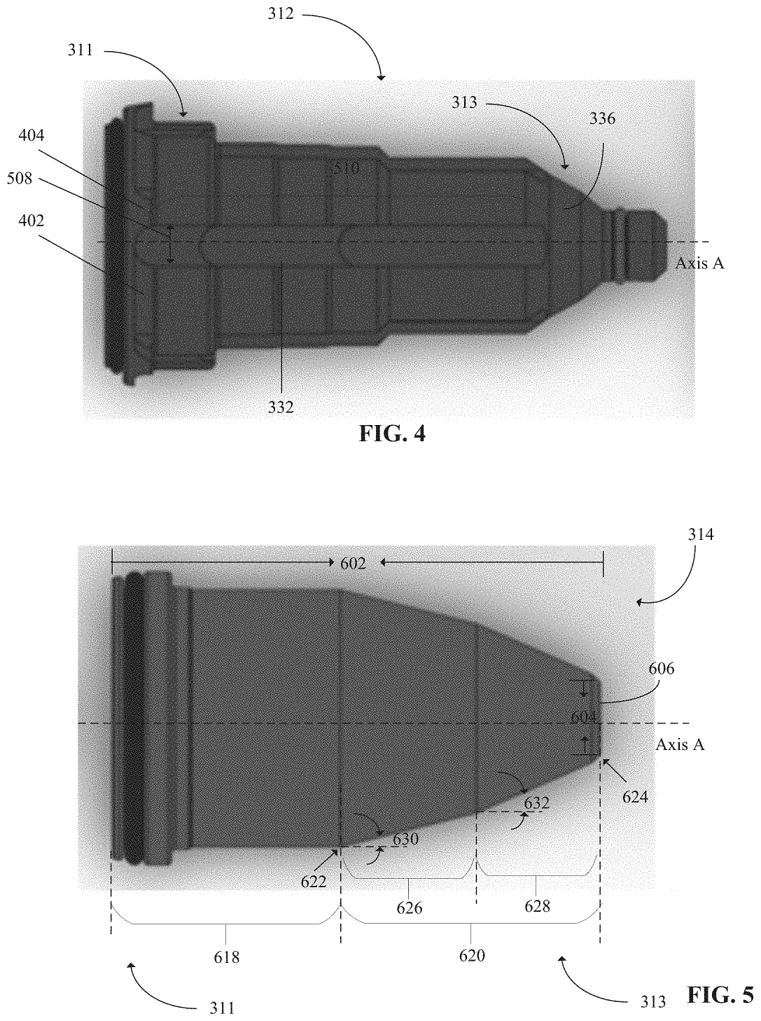

In operation, when a liquid coolant enters the nozzle 310 via the coolant inlet 324 at the proximal region 311 of the nozzle 310, the coolant is only provided to one or two of the windows 402 that are in fluid communication with the inlet 324, irrespective of the radial orientation between the nozzle body 312 and the nozzle jacket 314. Thereafter, the coolant is adapted to flow axially toward the distal region 313 of the nozzle 310 only via the coolant channel(s) 332 associated with the one or two inlet windows 402 (hereinafter referred to as the supply channel(s)). During the distal axial flow, the coolant is prevented from circumferentially bypassing to the other coolant channels due to the dividers 404 located between the windows 402. Once the coolant reaches the distal region 313 of the nozzle 310 between the nozzle body 312 and the nozzle jacket 314, the coolant merges into the circumferential channel 336 that is in fluid communication with the axially-extending supply coolant channels 332. The circumferential channel 336 is adapted to circulate the coolant flow around to cool the distal region 313 of the nozzle 310. Further, the circulating coolant is adapted to return from the circumferential channel 336 to the outlet 326 at the proximal region 311 of the nozzle 310 via only one or two of the coolant channels 332 (hereinafter referred to as the return channel(s)) that are offset (e.g., substantially opposite) from the supply coolant channel(s). This is because the return coolant channel(s) 332 are associated with the one or two windows 402 that are in fluid communication with coolant outlet 326. The remaining channels 332 do not conduct the return coolant flow because their corresponding windows 402 are not in fluid communication with the coolant outlet 326. Additionally, during the proximal axial flow, the return coolant is prevented from circumferentially bypassing to the other coolant channels due to the dividers 404 located between the windows 402. Once the coolant reaches the proximal region 311 of the nozzle 310 between the nozzle body 312 and the nozzle jacket 314, the coolant is expelled from the nozzle 310 via the coolant outlet 326. As described above, in various embodiments, the nozzle 310 is clocking independent, such that it can have (i) one coolant supply channel and one coolant return channel, (ii) two coolant supply channels and one coolant return channel, (iii) one coolant supply channel and two coolant return channels, or (iv) two coolant supply channels and two coolant return channels, regardless of the radial orientation between the nozzle body 312 and the nozzle jacket 314. For the configuration of FIGS. 3a and 3b, options (ii) and (iii) are possible. The exact number of coolant channels 332 used for supplying and returning the coolant in the nozzle 310 is generally dependent on the number of windows 402 present as well as the orientation of the nozzle body 312 relative to the nozzle jacket 314. It is understood that while the embodiments of FIGS. 3 and 4a and 4b show 5 coolant channels 332 and corresponding windows 402 and dividers 404; other numerical combinations of coolant channels 332, windows 402, and dividers 404 are considered in other embodiments. Further, the forming of these features in to nozzle body 312 as shown and described with regard to these embodiments, could also be accomplished by forming these features in to nozzle jacket 314 rather than nozzle body 312 and/or forming portions of these features in to both nozzle body 312 and nozzle jacket 314.

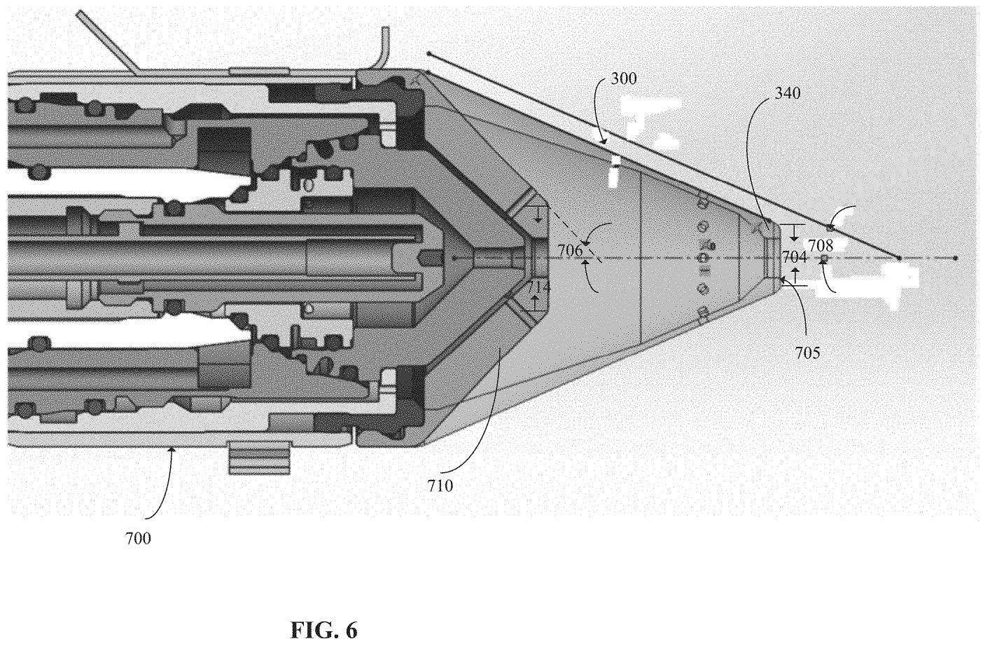

FIG. 4 shows a profile view of the nozzle body 312 of the nozzle 310 of the plasma arc torch 300 of FIG. 2, according to some embodiments of the present invention. As shown, the nozzle body 312 includes the coolant channels 332, where each coolant channel axially extends between a window 402 at the proximal region 311 of the nozzle 310 and the circumferential channel 336 at the distal region 313 of the nozzle 310. FIG. 5 shows a profile view of the nozzle jacket 314 of the nozzle 310 of the plasma arc torch of FIG. 2, according to some embodiments of the present invention. As shown, the nozzle jacket 314 generally defines an axial length 602 along the longitudinal axis A and a diameter 604 of an end face 606 at the distal region 313 of the nozzle 310. In some embodiments, each axial coolant channel 332 on the nozzle body 312 has a substantially rectangular cross section with a cross sectional width 508 of less than about 0.2 inches. The width 508 of an axial coolant channel 332 can be smaller than the width of a divider 404. In some embodiments, each axial coolant channel 332 has an axial length 510 along the longitudinal axis A of greater than about 1.2 inches. Each axial coolant channel 332 can axially extend at least about 75% of the axial length 602 of the nozzle jacket 314 when the nozzle body 312 and the nozzle jacket 314 are assembled. As illustrated in FIGS. 5 and 6, the clocking-independent features of the nozzle 310, including the windows 402, dividers 404, axial coolant channels 332, and circumferential coolant channel 336, are mostly located on the inner nozzle body 312. The nozzle jacket 314 is substantially free of these features. One advantage of this design is that milling and other manufacturing operations used to form these clocking-independent features are applied to a single nozzle piece, rather than jointly across both nozzle pieces, thereby reducing the cost and complexity of manufacturing the nozzle 310. In alternative embodiments, instead of forming both the windows 402 and the axially coolant channels 332 on the nozzle body 312, which is in the design of the nozzle 310, these features can be distributed between the nozzle body 312 and the nozzle jacket 314. For example, the axial coolant channels 332 can be disposed on the nozzle body 312, while the windows 402 (and the dividers 404 used to define the window 402) can be located on the nozzle jacket 314. The distributed windows and axial channels can have substantially the same spacing/size as their corresponding features for the nozzle 310 and achieve substantially the same coolant flow pattern as the nozzle 310 when the nozzle body and the nozzle jacket are assembled in a clocking-independent manner. In some embodiments, the windows 402 that are disposed on the nozzle jacket 314 can comprise a plurality of holes through the nozzle jacket 314.

In general, the nozzle design of FIGS. 3-6 achieves consistent combined flow areas for supply and return coolant of the nozzle 310 (e.g., consistent channel area) irrespective of the orientation between the nozzle body 312 and the nozzle jacket 314 (i.e., clocking-independent). In some embodiments, the number of windows 402 present in a nozzle 310 (e.g., 5) is the same as the number of dividers 404 to restrict circumferential coolant flow bypass. In alternative embodiments, the number of windows 402 is at least one more than the number of dividers 404 to restrict circumferential flow bypass and insure proper axial coolant flow to and from the distal region 313 of the nozzle 310. It has been found that nozzle configurations with two windows 402 do not always prevent circumferential coolant bypass. Nozzle configurations with three or four windows 402 can have one of: (i) one supply coolant channel and one return coolant channel, (ii) two supply coolant channels and one one return coolant channel or (iii) two supply coolant channels and two return coolant channels, depending on the orientation of the nozzle body 312 relative to the nozzle jacket 314 upon installation into the torch 300. Nozzle configurations with five windows 402 have more than one divider 404 to restrict circumferential bypass in/to each of the supply or return coolant flow directions, and have a total of 3 active coolant channels to the nozzle proximal region (i.e., two supply and one return channel or one supply and two return channels). Nozzle configurations with six or more windows 402 may reduce total coolant flow because of the large total divider area and may increase machining time, complexity, and cost. In some embodiments, nozzle configurations of the present invention can include more than one coolant channel 332 per window 402 to increase flow area, but this may introduce more machining cost and may still require at least five windows 402 to provide consistent flow area/performance.

In some embodiments, because the number of supply and return channels of the nozzle 310 is predictable independent of the radial orientation of the nozzle body 312 relative to the nozzle jacket 312, the pressure disparity (i.e., pressure drop/loss) between the coolant supply flow and coolant return flow through the nozzle 310 can be managed (e.g., a desired pressure disparity achieved) irrespective of the parts orientation. This can be achieved even if the number of coolant and supply channels are not the same. The total pressure drop in the flow path from the proximal region 311 to the distal region 313 of the nozzle 310 and back from the distal region 313 to the proximal region 311 of the nozzle 310 is defined by the sum of the channels in both directions. The total pressure drop for the case of 2 supply channels and 1 return channel has a total pressure drop equal to 1 supply and 2 return channels. Thus, in this case the coolant supply and return channels are different in number but equal in total pressure drop through the nozzle 310. In some embodiments, the circumferential channel 336 is designed to have a sufficient wall thickness to enable effective component manufacturing while providing a sufficient flow area to limit the pressure disparity in the coolant flow path. Specifically, the wall thickness of the circumferential channel 336 can be sufficiently large such that (i) the circumferential channel 336 is structurally sound (e.g., won't break under operating conditions), (ii) enough thermal energy is conducted away from the distal region 313 of the nozzle 310, and/or (iii) enough spacing among the nozzle components is achieved to minimize pressure disparity in the coolant flow.

In another aspect, both the nozzle body 312 and the nozzle jacket 314 of the nozzle 310 are electrically conductive and constructed from the same or different electrically conductive materials. For example, the nozzle jacket 314 can be made from brass and the nozzle body 312 can be made from copper. FIG. 2 illustrates an exemplary current path 346 through the nozzle 310. As shown, the current path 346 (e.g., pilot arc current path) can be from the conductive nozzle body 312 to the conductive nozzle jacket 314, to the retaining cap 342 and to the torch body 300 via a torch current ring 348. This current path 346 is different from a prior art current path through a nozzle which comprises the current traveling directly from the nozzle body to the outer retaining cap without passing through the nozzle jacket. Therefore, in traditional torches, the nozzle jacket is not electrically conductive (e.g., made from a plastic material). The current path 346 of FIG. 2 is a path of pilot arc current that sustains the plasma arc from the time of torch ignition to the time of arc transfer from the nozzle 310 to the workpiece. If the current path 346 is intermittent or poorly defined, torch damage may occur.

In yet another aspect, the consumable components of the plasma arc torch 300 are shaped and dimensioned to enhance bevel cutting. The narrow, lengthened cooling design of the clocking-independent nozzle 310 as described above drives the design of a generally longer and steeper torch 300 capable of delivering a plasma arc closer to parallel relative to the surface of a workpiece being processed, in comparison to prior art liquid-cooled plasma arc torches. FIG. 6 shows a stack-up comparison of a prior art liquid-cooled plasma arc torch 700 with the liquid-cooled plasma arc torch 300 of FIG. 2, according to some embodiments of the present invention. As shown, the shield 340 of the torch 300 is considerably longer than the prior art shield 710 of the prior art torch 700 with the diameter 704 of the end face 705 of the shield 340 significantly reduced (i.e., narrower) in comparison to the end face diameter 714 of the prior art shield 710. Further, the shield 710 of the prior art torch 700 (and other prior art torches) can have a half-cone angle 706 of greater than about 45 degrees, whereas the half-cone angle 708 of the shield 340 of the plasma arc torch 300 (and other torch embodiments of the present invention), which incorporate the non-clocked cooling designs as described above, can be less than about 25 degrees. These smaller angles are a feature of the invention not present in other high-amperage (over 130 amp) liquid-cooled nozzles.

Referring to FIG. 5, in some embodiments, the axial length 602 of the nozzle jacket 314 is greater than about 1.5 inches. In some embodiments, the end face diameter 604 of the nozzle jacket 312 is less than about 0.4 inches. In some embodiments, the ratio of the axial length 602 to the end face diameter 604 of the nozzle jacket 312 is greater than about 1.4, such as greater than about 1.8 (e.g., 1.88), greater than about 2, greater than about 4 (e.g., 4.25), etc. In some embodiments, the nozzle jacket 314 is defined by two sections, a proximal conical section 618 and a distal conical section 620, where each conical section extends about 50% of the overall axial length 602 of the jacket 314. The distal conical section 620 has (i) a proximal end 622 axially located at about the midpoint of the axial jacket length 602 and (ii) a distal end 624 that comprises the distal end face 606 of the nozzle jacket 314, which tapers radially inward at the distal tip of the jacket 314. The distal conical section 620 of the nozzle jacket 314 can be further divided into two angled sections with a first angled section 626 radially extending from the midpoint 622 of the jacket length 602 toward the distal end of the nozzle 310, and a second angled section 628 extending from the first angled section 626 to the distal end face 606 of the jacket 314. The first angled section 626 defines a first angle 630 relative to the longitudinal axis A, and the second angled section 628 defines a second angle 632 relative to the longitudinal axis A. In some embodiments, the second angle 632 is larger than the first angle 630 such that the second angled section 628 is more tapered relative to the longitudinal axis A than the first angled section 626. For example, the first angle 630 of the first angled section 626 can be about 14 degrees and the second angle 632 of the second angled section 628 can be about 23.5 degrees.

In some embodiments, if the optional shield 340 is assembled into the torch 300 such that it substantially surrounds an external surface of the nozzle jacket 314, the shield 340 also comprises a proximal conical section and a distal conical section with two angled sections having about the same angular shapes/profiles as their corresponding sections of the nozzle jacket 314. In some embodiments, the diameter of the distal end face 360 of the shield 340 (shown in FIG. 2) is about 0.45 inches. In some embodiments, the electrode 305 (shown in FIG. 2) is suitably elongated to be compatible with the overall elongated design of the plasma arc torch 300. For example, an axial length of the electrode 305 can be greater than about 2.4 inches. The electrode can include a cooling bore 362 having an axial length greater than about 1.8 inches, where the cooling bore 362 is configured to receive a coolant tube.

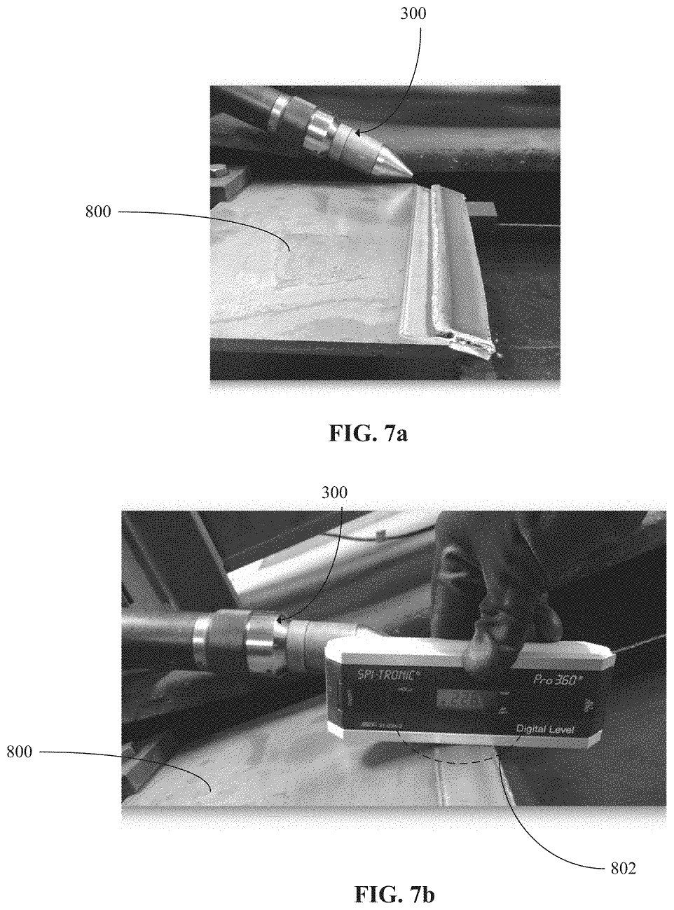

FIGS. 7a and 7b show utilization of the plasma arc torch 300 of FIG. 2 in cutting a workpiece 800 at an angle 802 close to parallel to the surface of the workpiece 800, according to some embodiments of the present invention. As shown, the clocking-independent nozzle 310 of the torch 300 with lengthened cooling creates an overall longer and steeper conical profile at the distal region of the torch 300, thereby enabling the torch 300 to deliver a plasma arc more/closer to parallel relative to the surface of the workpiece 800 being processed. For example, the plasma arc torch 300 can be used to cut at a steep angle 802 (e.g., about 22.6 degrees) on the steel workpiece 800.

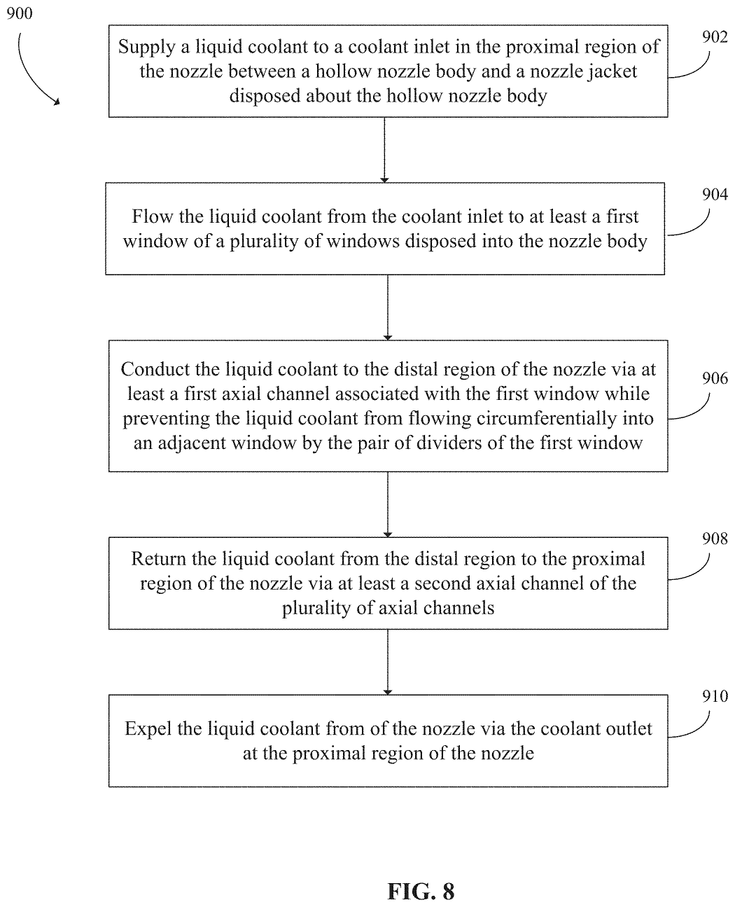

FIG. 8 shows an exemplary process 900 for conducting a liquid coolant through the clocking-independent nozzle 310 of the plasma arc torch 300 of FIG. 2, according to some embodiments of the present invention. As described above, the nozzle 310 includes axial coolant channels 332 that define a circuitous coolant flow path from the nozzle coolant inlet 324 located at the proximal region 311 of the nozzle 310 to the distal region 313 of the nozzle 310 and back to the nozzle coolant outlet 326 at the proximal region 311 of the nozzle 310 on a substantially opposite circumferential side of the nozzle 310. Specifically, a liquid coolant is first supplied to the nozzle coolant inlet 324 at the proximal region 311 of the nozzle 310 between the nozzle body 312 and the nozzle jacket 314 (step 902). From the inlet 324, the liquid coolant is adapted to flow to at least one coolant window 402 of multiple coolant windows (e.g., 5 windows as shown in FIG. 3a) that are disposed circumferentially around the nozzle body 312 (step 904), independent of a circumferential orientation between the nozzle body 312 and the nozzle jacket 314. In some embodiments, the liquid coolant is adapted to flow through two coolant windows 402 that are in fluid communication with the inlet 324. From the coolant window(s) 402, the liquid coolant is further conducted to the axial coolant channel(s) 332 disposed within each of the windows 402. The axial channel(s) 332 are adapted to conduct the liquid coolant from the inlet 324 at the proximal region 311 of the nozzle 310 to the distal region 313 of the nozzle 310 (step 906), such as to the circumferential channel 336 at the distal region 313. The coolant flow through each axial channel 332 is substantially confined to the window 402 corresponding to the channel 332 at least because the pair of dividers 404 defining that window 402 prevents the liquid coolant from flowing circumferentially into an adjacent window 402. After reaching the distal region 313 of the nozzle 310, the coolant flow is configured to circulate around the nozzle 310 and return to the proximal region 311 on a side that is circumferentially offset (e.g., opposite) from the coolant inlet 324, the associated window(s) 402 and the axial coolant channel(s) 332 through which the coolant flow is conducted to the distal region 313 (step 908). For example, the coolant flow can circulate around the circumferential channel 336 prior to being returned. In some embodiments, the coolant flow is returned from the distal region 313 to the proximal region 311 via at least one opposite axial channel 332 that is located within an opposite window 402 in fluid communication with the coolant outlet 326, irrespective of a circumferential orientation between the nozzle body 312 and the nozzle jacket 314. For example, the return coolant flow can be conducted over two axial channels 332 associated with respective ones of two coolant windows 402, both of which are in fluid communication with the coolant outlet 326. Upon reaching the proximal region 311 of the nozzle 310, the liquid coolant is adapted to be expelled by the coolant outlet 326 from the nozzle 310 (step 910).

In an exemplary operation, independent of a circumferential orientation between the nozzle body 312 and the nozzle jacket 314, the supply coolant flow is conducted over one window 402 and one corresponding axial channel 332 in fluid communication with the inlet 324, while the return coolant flow is conducted over two windows 404 and two corresponding axial channels 332 in fluid communication with the outlet 326. In alternative embodiments, the supply coolant flow is over two windows/two corresponding axial channels while the return coolant flow is over one window/one corresponding axial channel. Because a predicted number of supply and return axial channels 332 is used for conducting a coolant flow through the nozzle 310 independent of the circumferential orientation between the nozzle body 312 and the nozzle jacket 314, a desired (e.g., minimized) pressure disparity between the supply and coolant flows can be achieved.

As described above, advantages of the present invention include eliminating the need for end users to clock the nozzle for installation into the plasma arc torch and/or clock the nozzle body relative to the nozzle jacket for assembling the nozzle, thus facilitating error-proof installation and assembly. In addition, the nozzle coolant designs of the present invention frees more design space for added torch features. Further, the nozzle coolant designs of the present invention drive the design for a more elongated, narrowed torch that can cut sharp angles and/or into confined spaces with improved cooling.

It should also be understood that various aspects and embodiments of the invention can be combined in various ways. Based on the teachings of this specification, a person of ordinary skill in the art can readily determine how to combine these various embodiments. For example, in some embodiments, any of the aspects above can include one or more of the above features. One embodiment of the invention can provide all of the above features and advantages.

What is claimed is:

1. A nozzle for a liquid cooled plasma arc cutting torch, the nozzle defining a central longitudinal axis extending between a proximal region and a distal region of the nozzle with a plasma exit orifice disposed along the longitudinal axis at the distal region, the nozzle comprising:
a hollow nozzle body;
a nozzle jacket disposed about an external surface of the nozzle body, the jacket defining (i) a length along the central longitudinal axis and (ii) a diameter of a distal tip of the jacket at the distal region of the nozzle, wherein the length is greater than about 1.5 inches and a ratio of the length to the diameter is greater than about 1.4;
a coolant inlet and a coolant outlet defined between the nozzle body and nozzle jacket at the proximal region of the nozzle, the coolant inlet configured to receive a liquid coolant flow from a torch body of the plasma arc cutting torch to cool the nozzle and the coolant outlet configured to return the coolant flow to the torch body; and
a plurality of coolant channels cooperatively defined between the nozzle body and the nozzle jacket, the plurality of coolant channels extending axially between the proximal region and the distal region of the nozzle.

2. The nozzle of claim 1, wherein the coolant inlet and the coolant outlet are (i) substantially axially aligned along the longitudinal axis and (ii) circumferentially offset relative to each other.

3. The nozzle of claim 1, further comprising a plurality of windows disposed into the nozzle body, each window being circumferentially defined by a pair of adjacent dividers of the nozzle body.

4. The nozzle of claim 3, wherein each divider is configured to prevent the coolant flow in one window from flowing circumferentially into an adjacent window to restrict coolant flow bypass.

5. The nozzle of claim 4, wherein each coolant channel is disposed in the nozzle body within a corresponding window such that the coolant channel is located between a pair of the dividers associated with the corresponding window.

6. The nozzle of claim 5, wherein the coolant inlet is in fluid communication with at least one of the plurality of windows, such that the coolant flow received from the coolant inlet is adapted to flow through the at least one coolant channel associated with the corresponding window.

7. The nozzle of claim 5, wherein the coolant outlet is in fluid communication with at least one of the windows, such that the coolant flow returned to the coolant outlet is adapted to flow through the at least one coolant channel associated with the corresponding window.

8. The nozzle of claim 5, wherein one of the plurality of coolant channels is in fluid communication with one of the coolant inlet or outlet, and two of the plurality of coolant channels are in fluid communication with other one of the coolant inlet or outlet, irrespective of a radial orientation between the nozzle jacket and the nozzle body.

9. The nozzle of claim 8, wherein at least one of the plurality of coolant channels is fluidly insulated from the coolant inlet and the coolant outlet, thereby prevented from conducting a fluid flow therethrough.

10. The nozzle of claim 1, wherein the jacket includes a distal conical section that axially extends about 50% of the length of the jacket, the distal conical section having (i) a proximal end axially located at about a midpoint of the jacket length and (ii) a distal end tapered radially inward at the distal tip of the jacket.

11. The nozzle of claim 10, wherein the distal conical section comprises two angled sections, a first angled section radially extending from the midpoint of the jacket length toward the distal end of the nozzle, and a second angled section extending from the first angled section to the distal tip of the jacket, wherein the first angled section defines a first angle relative to the longitudinal axis and the second angled section defines a second angle relative to the longitudinal axis, the second angle being larger than the first angle such that the second angled section is more tapered than the first angled section.

12. The nozzle of claim 11, wherein the first angle is about 14 degrees and the second angle is about 23.5 degrees.

13. The nozzle of claim 11, further comprising a shield disposed about an external surface of the nozzle jacket, the shield comprising a distal conical section with two angled sections, each angled section having about the same angle as the corresponding section of the nozzle jacket.

14. The nozzle of claim 13, wherein a diameter of an end face at a distal tip of the shield is about 0.45 inches.

15. The nozzle of claim 1, wherein the plurality of liquid coolant channels axially extend at least about 75% of the length of the nozzle jacket.

16. The nozzle of claim 1, wherein each coolant channel has a substantially rectangular cross section.

17. The nozzle of claim 1, where an axial length of each coolant channel is greater than about 1.2 inches.

18. The nozzle of claim 1, wherein a width of each coolant channel is less than about 0.2 inches.

19. The nozzle of claim 1, wherein the plurality of coolant channels fluidly merge into a circumferential channel at the distal region of the nozzle, the circumferential channel configured to circumferentially circulate a coolant flow about the distal region of the nozzle.

20. The nozzle of claims 19, wherein the circumferential channel is defined at least in part by a sealing member disposed between the nozzle body and the nozzle jacket, the sealing member having a diameter of between about 0.15 inches and about 0.3 inches.

21. The nozzle of claim 1, wherein the plasma arc torch is configured to operate at a current level of above about 120 amps.

22. The nozzle of claim 1, wherein both the nozzle body and the nozzle jacket are electrically conductive.

23. The nozzle of claim 21, wherein the nozzle jacket is constructed from brass.

24. The nozzle of claim 1, wherein the diameter of the distal tip of the jacket is less than about 0.4 inches.

25. A nozzle for a liquid cooled plasma arc cutting torch, the nozzle defining a central longitudinal axis extending between a proximal region and a distal region of the nozzle, the nozzle comprising:
a nozzle body including an internal surface shaped to form a portion of a plasma plenum and an external surface shaped to form a portion of a coolant flow path substantially about the nozzle body, the external surface defining a plurality of substantially axial channels extending from the proximal region to the distal region of the nozzle;
a nozzle jacket disposed about the external surface of the nozzle body and shaped to cooperatively form the plurality of axial channels with the nozzle body, the plurality of axial channels defining the coolant flow path about the nozzle body; and
a plurality of windows disposed into the nozzle body, each window being circumferentially defined by a pair of adjacent dividers of the nozzle body to prevent the coolant flow path through one window from flowing circumferentially into an adjacent window.

26. The nozzle of claim 25, wherein each axial channel is disposed in the external surface of the nozzle body within a corresponding window such that each coolant channel is located between a pair of the dividers associated with the corresponding window.

27. The nozzle of claim 26, wherein each axial channel is circumferentially isolated from one another via the dividers of the windows.

28. The nozzle of claim 25, wherein two windows of the plurality of windows are in fluid communication with a coolant inlet or a coolant outlet of the nozzle, and wherein the two windows are fluidly connected to respective ones of the axial channels, such that the corresponding coolant inlet or outlet is fluidly connected to two axial channels irrespective of a circumferential orientation between the nozzle jacket and the nozzle body.

29. The nozzle of claim 25, wherein one window of the plurality of windows is in fluid communication with a coolant inlet or a coolant outlet of the nozzle, and wherein the one window is fluidly connected to a corresponding axial channel, such that the corresponding coolant inlet or outlet is fluidly connected to one axial channel irrespective of a circumferential orientation between the nozzle jacket and the nozzle body.

30. The nozzle of claim 25, wherein an axial length of each axial channel is greater than about 1.2 inches.

31. The nozzle of claim 25, wherein a cross-sectional width of each axial channel is less than 0.2 inches.

32. The nozzle of claim 25, wherein the nozzle jacket is constructed from an electrically conductive material.

33. The nozzle of claim 25, wherein the plurality of windows comprise a plurality of holes formed through the nozzle jacket.

34. The nozzle of claim 25, wherein the nozzle jacket defines (i) a length along the central longitudinal axis and (ii) a diameter of a distal tip of the jacket at the distal region of the nozzle, the length being greater than about 1.5 inches and a ratio of the length to the diameter being greater than about 1.4.

35. A consumable set in a liquid cooled plasma arc cutting torch configured to direct a plasma arc to process a workpiece, the consumable set comprising:
an electrode;
a nozzle disposed about the electrode, the nozzle having a nozzle body, a nozzle jacket and a plurality of windows, wherein an external surface of the nozzle body and an internal surface of the nozzle jacket cooperatively define a plurality of axial channels for circulating a coolant flow about the nozzle, and wherein each axial channel is located within one of the windows that is defined by a pair of adjacent dividers configured to prevent the coolant flow in one window from circumferentially bypassing into an adjacent window; and
a shield disposed about the nozzle jacket.

36. The consumable set of claim 35, wherein an axial length of the electrode is greater than about 2.4 inches.

37. The consumable set of claim 35, wherein the electrodes includes a cooling bore having an axial length greater than about 1.8 inches.

38. The consumable set of claim 35, wherein the shield comprises substantially same shape and one or more angled sections as the nozzle jacket.

39. The consumable set of claim 35, where in a diameter of an end face at a distal tip of the shield is about 0.45 inches.

40. A method of conducting a liquid coolant through a nozzle of plasma arc cutting torch, the nozzle defining a central longitudinal axis extending between a proximal region and a distal region of the nozzle, the method comprising:
supplying the liquid coolant to a coolant inlet in the proximal region of the nozzle between a hollow nozzle body and a nozzle jacket disposed about the hollow nozzle body, wherein an external surface of the nozzle body and an internal surface of the nozzle jacket cooperatively define a plurality of axial channels that extend from the proximal region to the distal region;
flowing the liquid coolant from the coolant inlet to at least a first window of a plurality of windows disposed into the nozzle body, each window being circumferentially defined by a pair of adjacent dividers of the nozzle body, wherein each window includes at least one of the plurality of axial channels;
conducting the liquid coolant to the distal region of the nozzle via at least a first axial channel associated with the first window while preventing the liquid coolant from flowing circumferentially into an adjacent window by the pair of dividers of the first window;
returning the liquid coolant from the distal region to the proximal region of the nozzle via at least a second axial channel of the plurality of axial channels, wherein the at least second axial channel is located in a second window of the plurality of windows and the second window being in fluid communication with a coolant outlet located between the nozzle body and the nozzle jacket in the proximal region; and
expelling the liquid coolant from of the nozzle via the coolant outlet at the proximal region of the nozzle.

41. The method of claim 40, wherein the coolant inlet is fluid communication with at least the first axial channel and the coolant outlet is in fluid communication with at least the second axial channel irrespective of a circumferential orientation between the nozzle body and the nozzle jacket.

42. The method of claim 40, further comprising achieving a desired pressure disparity between the liquid coolant flow to the distal region and the liquid coolant flow to the proximal region irrespective of a radial orientation of the nozzle body relative to the nozzle jacket.

43. The method of claim 40, further comprising:
conducting the liquid coolant to the distal region of the nozzle via a pair of the plurality of axial channels corresponding to respective ones of a pair of the plurality of windows, the pair of windows being in fluid communication with the coolant inlet; and
returning the liquid coolant to the proximal region of the nozzle via a single one of the plurality of axial channels corresponding to a single one of the plurality of windows, the single window being in fluid communication with the coolant outlet,
wherein the single axial channel is (i) located substantially circumferentially opposite from the pair of axial channels and (ii) in fluid communication with the pair of axial channels at the distal region of the nozzle.

44. The method of claim 40, further comprising:
conducting the liquid coolant to the distal region of the nozzle via a single one of the plurality of axial channels corresponding to a single one of the plurality of windows, the single window being in fluid communication with the coolant inlet; and
returning the liquid coolant to the proximal region of the nozzle via a pair of the plurality of axial channels corresponding to respective ones of a pair of the plurality of windows, the pair of windows being in fluid communication with the coolant outlet,
wherein the single axial channel is (i) located substantially circumferentially opposite from the pair of axial channels and (ii) in fluid communication with the pair of axial channels at the distal region of the nozzle.

45. A nozzle for a liquid cooled plasma arc cutting torch, the nozzle defining a central longitudinal axis extending between a proximal region and a distal region of the nozzle with a plasma exit orifice disposed along the longitudinal axis at the distal region, the nozzle comprising:
a hollow nozzle body;
a nozzle jacket disposed about an external surface of the nozzle body;
a coolant inlet and a coolant outlet defined between the nozzle body and nozzle jacket at the proximal region of the nozzle, the coolant inlet configured to receive a liquid coolant flow from a torch body of the plasma arc cutting torch to cool the nozzle and the coolant outlet configured to return the liquid coolant flow to the torch body;
a plurality of windows cooperatively defined between the nozzle body and the nozzle jacket and located at the proximal region of the nozzle, the plurality of windows including:
at least a first window in fluid communication with the coolant inlet for receiving the liquid coolant flow from the coolant inlet and flowing the liquid coolant to the nozzle, and
at least a second window in fluid communication with the coolant outlet for returning the liquid coolant flow from the nozzle to the coolant outlet;
wherein the first and second windows are in fluid communication with each other within the nozzle; and
a plurality of axial channels cooperatively defined between the nozzle body and the nozzle jacket, each of the plurality of axial channels extending between the proximal and distal regions of the nozzle, the plurality of axial channels including:
a single axial channel in fluid communication with one of the first or second window; and
a pair of axial channels in fluid communication with another of the first or second window, the pair of axial channels located substantially circumferentially opposite from the single axial channel,
wherein the single axial channel and the pair of axial channels are in fluid communication at the distal region of the nozzle for passing the liquid coolant flow between the first and second windows, such that a desired pressure drop for the liquid coolant flow is established between the single axial channel and the pair of axial channels independent of a circumferential orientation of the nozzle body relative to the nozzle jacket.
